(19) United States
(12) Patent Application Publication
(10) Pub. No.: US 2020/0188824 A1
(43) Pub. Date: Jun. 18, 2020

(54) Filters having a Plurality of Projections

(71) Applicants: James R. Munson, Flemington, NJ (US); James Stryker, Pittstown, NJ (US); George E. Hicks, Elizabeth, IN (US); Dennis N. Malaba, Uniontown, OH (US)

(72) Inventors: James R. Munson, Flemington, NJ (US); James Stryker, Pittstown, NJ (US); George E. Hicks, Elizabeth, IN (US); Dennis N. Malaba, Uniontown, OH (US)

(21) Appl. No.: 16/710,569

(22) Filed: Dec. 11, 2019

Related U.S. Application Data
(60) Provisional application No. 62/781,278, filed on Dec. 18, 2018.

(51) Int. Cl. B01D 39/18; B01J 20/28; B01J 20/24; B01J 20/10

(52) U.S. Cl. CPC B01D 39/18; B01J 20/28028; B01D 2239/0407; B01J 20/10; B01J 20/24

(57) ABSTRACT

A medium for filtering a fluid, such as cooking oil, biodiesel fuel, and fruit-based and vegetable-based beverages, which comprises a filter having a planar surface and at least one projection which projects upwardly from the planar surface. The filter may be impregnated with at least one adsorbent material for removing impurities from the fluid. The at least one projection projects upwardly from the planar surface such that the filter provides for a three-dimensional surface providing additional contact area for the filter. The three-dimensional surface pattern is designed to provide longer filter life before plugging or fouling and allow for controlled flow of the fluid through the filter.

This application claims priority based on provisional Application Ser. No. 62/781,278, filed Dec. 18, 2018, the contents of which are incorporated by reference in their entirety.

This invention relates to filter media that filter and purify fluids, such as used cooking oils, unrefined edible oils, fruit-based and vegetable-based beverages, such as beer and wine, and biodiesel fuel. More particularly, this invention relates to filter media including a filter having a planar surface and at least one projection that projects upwardly from the planar surface. The filter may be impregnated with at least one adsorbent material for removing impurities from the fluid. The filter provides for controlled flow of the fluid through the filter.

Fluids such as, for example, used cooking oil, unrefined edible oils, fruit-based and vegetable-based beverages, and biodiesel fuel, may be filtered and/or purified using a filter which may be in the form of a filter pad or filter paper. The filter pad or paper, in some embodiments, may be part of a filter envelope. In some cases, the filter pad or filter paper may be impregnated with at least one adsorbent material, which is in the form of a powder, that removes impurities from the fluid.

For example, U.S. Pat. Nos. 6,312,598 and 6,482,326 disclose a filter envelope for removing impurities from a fluid, such as used cooking oil. The filter envelope includes a filter pad and a filter paper which enclose a metal spacer grid. The filter pad has a greater permeability than the filter paper, whereby the flow of the used cooking oil is directed to the filter pad. The filter pad and filter paper are formed from cellulosic fibers. The filter pad is impregnated with magnesium silicate, whereby the magnesium silicate is contained within the fiber matrix of the filter pad, and the magnesium silicate removes impurities from the used cooking oil as it passes through the filter pad.

U.S. Pat. Nos. 5,143,604; 5,330,638; 5,354,455; and 5,449,469 disclose a rectangular filter pad that may be formed with a bumpy surface in order to increase the total surface area for removal of larger contaminants.

The filter pads described in the above-mentioned patents, however, are susceptible to being plugged or fouled by solid impurities, each as, for example, solid pieces of food when used cooking oil is filtered. Such solid impurities accumulate on the surface of the filter pad, whereby the flow of the fluid through the filter pad is impeded, and/or there is insufficient contact of the fluid with any adsorbent purifying materials which may be present on or in the filter pad.

It therefore is an object of the present invention to provide a filter that has a surface pattern that provides for longer filter life before plugging or fouling and allows for controlled flow of the fluid through the filter.

In accordance with an aspect of the present invention, there is provided a medium for filtering a fluid. The medium comprises a filter having a planar surface and at least one projection which projects upwardly from the planar surface such that the filter medium provides for a controlled flow of a fluid through the filter.

In a non-limiting embodiment, the filter is impregnated with at least one adsorbent material for removing impurities from the fluid, and wherein the at least one projection projects upwardly from the planar surface such that the filter provides for controlled flow of the fluid through the filter and the at least one adsorbent material impregnated in the filter.

Adsorbent materials with which the filter may be impregnated include, but are not limited to, magnesium silicate, magnesium aluminum silicate, calcium silicate, sodium silicate, activated carbon, silica gel, magnesium phosphate, metal hydroxides, metal oxides, metal carbonates, metal bicarbonates, sodium sesquicarbonate, metal silicates, bleaching clays, bleaching earths, bentonite clay, alumina, diatomite, alkaline earth metal hydroxides, alkaline earth metal oxides, alkali metal carbonates, alkali metal bicarbonates, alkaline earth metal carbonates, alkali metal silicates, perlite, diatomaceous earth, and combinations thereof.

In a non-limiting embodiment, the at least one adsorbent material is magnesium silicate.

The at least one projection may have a variety of shapes, including, but not limited to, hemispherical, oval, frustoconical, conical, pyramidal, cylindrical, triangular prism, rectangular prism, and trapezoidal prism. In other embodiments, the at least one projection may be an arrangement of rectangular prisms in a variety of polygonal shapes, such as, for example, triangular, quadrilateral (including square, rectangular, parallelogram, trapezoid, and rhombus), pentagonal, hexagonal, heptagonal, octagonal, and the like, or intersecting rectangular prisms, such as in the form of a cross, for example. It is to be understood, however, that the scope of the present invention is not to be limited to any particular shape of projection.

In a non-limiting embodiment, the filter has a plurality of projections. In another non-limiting embodiment, the plurality of projections are arranged in a pattern having at least one row and at least one column. In yet another non-limiting embodiment, the plurality of projections are arranged in a pattern having at least two rows and two columns.

In a non-limiting embodiment, the at least one projection should have a height sufficient to provide for controlled flow of the fluid through the filter, and when the filter is impregnated with at least one adsorbent material, to provide for controlled flow of the fluid through the at least one adsorbent material impregnated in the filter. In a non-limiting embodiment, the at least one projection has a height such that the ratio of the height of the at least one projection to the thickness of the filter is from about 1:6 to about 3:1. In another non-limiting embodiment, the at least one projection has a height such that the ratio of the height of the at least one projection to the thickness of the filter is from about 1:4 to about 2:1.

In another non-limiting embodiment, the at least one projection has a height of from about 1/32 inch to about 1 inch. In a further non-limiting embodiment, the at least one projection has a height of from about 1/16 inch to about 5/16 inch.

The filter may be formed from a variety of materials which are known to those skilled in the art. In a non-limiting embodiment, the filter contains cellulosic fibers. Cellulosic fibers which may be employed include, but are not limited to, those formed from wood pulp. Examples of such wood pulp which may be employed include those sold under the trade name “Regular Kraft” by Weyerhaueuser Company of Federal Way, Wash., and those sold under the trade name “Tyee Kraft”, also by Weyerhaueuser Company. In another non-limiting embodiment, the filter is formed from cellulosic fibers and resin binder. Resin binders which may be employed include melamine-formaldehyde resins, urea-formaldehyde resins, or any number of “food grade” commercially available resins.

In a non-limiting embodiment, at least one adsorbent material is impregnated in the filter, whereby the at least one adsorbent material is contained within the fiber matrix.

In another non-limiting embodiment, the filter is formed from cellulosic fibers and a passive adsorbent, such as for example, diatomaceous earth or perlite, whereby the passive adsorbent is contained within the fiber matrix.

### BRIEF DESCRIPTION OF THE DRAWINGS

The invention now will be described with respect to the drawings, wherein:

FIG. 1 is a perspective view of a first non-limiting embodiment of a filter pad having raised projections in accordance with the present invention; and

FIG. 2 is a perspective view of a second non-limiting embodiment of a filter pad having raised projections in accordance with the present invention.

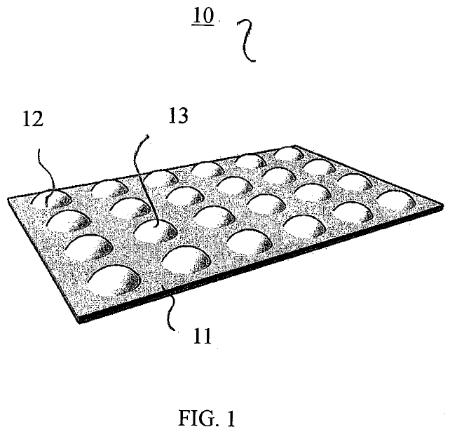

Referring now to the drawings, in a first non-limiting embodiment, as shown in FIG. 1, a filter pad 10 has a flat, or planar surface 11, and a plurality of hemispherical projections 12 extending upwardly from surface 11. Each hemispherical projection 12 has an apex 13. The hemispherical projections 12 are arranged in “non-staggered” rows and columns.

Filter pad 10 may be formed initially as a flat, or planar pad from materials known to those skilled in the art, such as cellulosic fibers as hereinabove described, alone or in combination with “food grade” commercially available resin binders. Filter pad 10 also is impregnated with at least one adsorbent material that adsorbs impurities from fluid, such as those hereinabove described. After the flat or planar filter pad is formed, the flat or planar pad is contacted with a plate or mold that has upwardly extending projections from a planar surface, whereby a plurality of upwardly extending hemispherical projections 12 from the planar surface 11 are formed in the filter pad 10.

Each upwardly extending hemispherical projection 12 has an apex 13. Each hemispherical projection 12 is formed such that the ratio of the distance from planar surface 11 to apex 13 to the thickness of filter pad 10 is from about 1:6 to about 3:1. Alternatively, the distance from planar surface 11 to apex 13 is from about 1/32 inch to about 1 inch.

Thus, filter pad 10 has an increased surface area as compared to flat or planar filter pads having the same length and width. In addition, because filter pad 10 is impregnated with at least one adsorbent material, the filter pad provides a controlled flow of the fluid through filter pad 10 and the at least one adsorbent material impregnated in filter pad 10.

More particularly, filter pad 10 is used in the purification of a fluid, such as, for example, used cooking oil in order to remove free fatty acids or other impurities, or fruit-based or vegetable-based beverages, such as beer, wine, or fruit juices in order to remove chill haze components, or biodiesel fuel in order to remove impurities, such as soap, glycerides, alcohols and other impurities formed during the manufacturing process. In some cases, such as when used cooking oil is purified, the fluid may include solid materials such as particles or crumbs of food.

As filter pad 10 is contacted with a liquid to be purified, the liquid contacts the planar surface 11 and the hemispherical projections 12 of filter pad 10. As the liquid is passed through filter pad 10, the liquid contacts the adsorbent material impregnated in planar surface 11 and hemispherical projections 12 of filter pad 10, whereby impurities are removed from the fluid. As more liquid is passed through filter pad 10, the planar surface 11 of filter pad 10 becomes plugged or fouled, especially if the liquid contains solid impurities such as food particles or crumbs. As planar surface 11 is plugged or fouled, the adsorbent material contained in the planar surface 11 no longer is available to be contacted by the liquid. Although the planar surface 11 becomes plugged or fouled, hemispherical projections 12 may remain exposed to the liquid to be purified, whereby the liquid contacts the at least one adsorbent material impregnated in hemispherical projections 12, whereby the liquid continues to be purified. Thus, filter pad 10 provides controlled flow of the fluid through filter pad 10 and the at least one adsorbent material impregnated in filter pad 10.

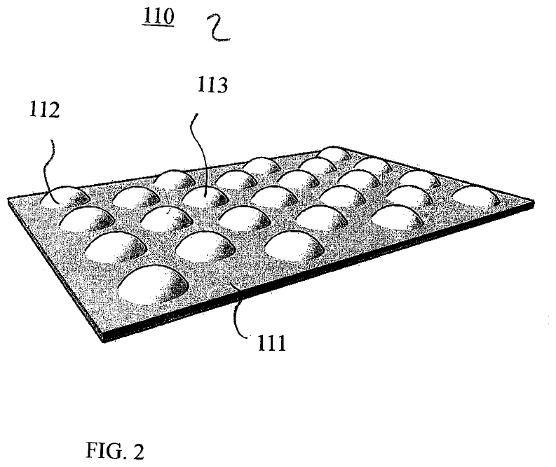

In a second non-limiting embodiment, as shown in FIG. 2, a filter pad 110 has a flat, or planar surface 111, and a plurality of hemispherical projections 112 extending upwardly from surface 111. Each hemispherical projection 112 has an apex 113.

Filter pad 110 is formed in essentially the same manner as filter pad 10, except that the hemispherical projections 112 are arranged in a plurality of “staggered” rows and columns. Each hemispherical projection 112 is formed such that the ratio of the distance from planar surface 111 to apex 113 to the thickness of filter pad 110 is from about 1:6 to about 3:1.

The disclosures of all patents and publications are incorporated by reference to the same extent as if each patent and publication were incorporated individually by reference.

It is to be understood, however, that the scope of the present invention is not to be limited to the specific embodiments described above. The invention may be practiced other than as particularly described and still be within the scope of the accompanying claims.

What is claimed is:

1. A medium for filtering a fluid, said medium comprising:
a filter having a planar surface and at least one projection which projects upwardly from said planar surface, wherein said filter is impregnated with at least one adsorbent material for removing impurities from said fluid, and wherein said at least one projection projects upwardly from said planar surface such that said filter provides for controlled flow of said fluid through said filter.

2. The medium of claim 1 wherein said at least one projection has a hemispherical shape.

3. The medium of claim 1 wherein said at least one projection has a frustoconical shape.

4. The medium of claim 1 wherein said at least one projection has a conical shape.

5. The medium of claim 1 wherein said at least one projection has a pyramidal shape.

6. The medium of claim 1 wherein said at least one projection has a cylindrical shape.

7. The medium of claim 1 wherein said at least one projection has a triangular prism shape.

8. The medium of claim 1 wherein said at least one projection has a rectangular prism shape.

9. The medium of claim 1 wherein said filter has a plurality of projections.

10. The medium of claim 9 wherein said filter has a plurality of projections that are arranged in a pattern having at least one row and at least one column.

11. The medium of claim 10 wherein said filter has a plurality of projections that are arranged in a pattern having at least two rows and two columns.

12. The medium of claim 1 wherein said filter contains cellulosic fibers.

13. The medium of claim 1 wherein said at least one adsorbent material is selected from the group consisting of magnesium silicate, magnesium aluminum silicate, calcium silicate, sodium silicate, activated carbon, silica gel, magnesium phosphate, metal hydroxides, metal oxides, metal carbonates, metal bicarbonates, sodium sequicarbontate, metal silicates, bleaching clays, bleaching earths, bentonite clay, alumina, diatomite, alkaline earth metal hydroxides, alkaline earth metal oxides, alkali metal carbonates, alkali metal bicarbonates, alkaline earth metal carbonates, alkali metal silicates, diatomaceous earth, and combinations thereof.

14. The medium of claim 13 wherein said at least one adsorbent material is magnesium silicate.

15. The medium of claim 1 wherein said at least one projection has a height such that the ratio of the height of said at least one projection to the thickness of said filter is from about 1:6 to about 3:1.

16. The medium of claim 15 wherein said at least one projection has a height such that the ratio of the height of said at least one projection to the thickness of said filter is from about 1:4 to about 2:1.
